(19) United States
(12) Patent Application Publication
(10) Pub. No.: US 2014/0370282 A1
(43) Pub. Date: Dec. 18, 2014

(54) METHOD OF PRODUCING CARBON FIBERS

(71) Applicant: SHOWA DENKO K.K., Tokyo (JP)

(72) Inventors: Ryuji Yamamoto, Minato-ku (JP); Yuusuke Yamada, Minato-ku (JP); Takeshi Nakamura, Minato-ku (JP)

(21) Appl. No.: 14/369,315

(22) PCT Filed: Dec. 27, 2012
(86) PCT No.: PCT/JP2012/008356

§ 371 Date: Jun. 27, 2014

(30) Foreign Application Priority Data
Dec. 27, 2011 (JP) 2011-285730

(51) Int. Cl. C01B 31/02; H01B 1/04

(52) U.S. Cl. CPC C01B 31/02; H01B 1/04
USPC 428/367; 423/447.3; 423/447.2

(57) ABSTRACT

Provided is a method of efficiently producing carbon fibers that can impart sufficient electrical or thermal conductivity to a material even by the addition of a small amount of the carbon fibers. The method of producing carbon fibers involves preparing a catalyst by allowing a carrier composed of silica-titania particles comprising silica in the core and titania in the shell of the particle to support a catalytic element, such as Fe element, Co element, Mo element, or V element, and bringing the catalyst into contact with a carbon element-containing material, such as methane, ethane, ethylene, or acetylene, under heating region at about 500 to 1000° C.

### TECHNICAL FIELD

The present invention relates to a method of producing carbon fibers. More specifically, the present invention relates to a method of efficiently producing carbon fibers that can impart sufficient electrical or thermal conductivity to a material even by the addition of a small amount of the carbon fibers.

### BACKGROUND ART

Carbon fibers have been proposed to be used as a filler for improving electrical or thermal conductivity of resins, metals, ceramics, or other materials, as an electron-emitting material for field emission displays (FEDs), as a catalyst carrier for various reactions, as a medium for occluding hydrogen, methane, or other gases, or as an electrode material for an electrochemical device such as a battery or capacitor or an additive to an electrode material.

As a method of producing carbon fibers, a method of growing carbon fibers using a catalyst as a nucleus, so-called chemical vapor deposition (hereinafter, referred to as CVD), is known. As CVD for producing carbon fibers, there are known a method using a catalyst composed of a catalytic element and a carrier supporting it and a method by growing a catalyst through thermal decomposition of, for example, an organometallic complex in a vapor phase without using a carrier (floating catalyst method).

The carbon fibers prepared by the floating catalyst method have many crystal defects in the carbon layer and too low crystallinity and thereby do not provide electrical conductivity even if it is added as a filler to, for example, a resin. A high-temperature heat treatment of the carbon fibers prepared by the floating catalyst method can increase the electrical conductivity of the carbon fibers themselves, but results in the effect of imparting electrical conductivity to materials such as a resin being not necessarily sufficient.

The method of producing carbon fibers using a supported catalyst can be roughly classified into a method using a plate carrier (basal plate method) and a method using a granular carrier.

The method using a plate carrier involves complicated steps, such as supporting of a catalyst on a plate carrier and collection of carbon fibers from the plate carrier, and is therefore unsuitable for industrial mass-production due to economic reasons.

In the method using a granular carrier, since the specific surface area of the catalyst carrier is larger than that in the method using a plate carrier, the method has advantages such as not only high device efficiency but also applicability to reactors for various chemical synthesis and production systems for batch treatment, such as the basal plate method, and also continuous treatment.

Examples of the granular carrier include alumina, magnesia, silica, zeolite, and aluminum hydroxide. For example, Patent Literature 1 discloses preparation of aggregates of microfilaments using a catalyst prepared using γ-alumina or magnesia as a carrier.

Patent Literature 2 describes that carbon fiber aggregates can be prepared by using a catalyst composed of a catalytic metal or catalytic metal precursor supported on a granular carrier prepared by heat treatment of aluminum hydroxide.

### CITATION LIST

### Patent Literature

[Patent Literature 1] U.S. Pat. No. 5,456,897
[Patent Literature 2] WO2010/101215

### SUMMARY OF INVENTION

### Technical Problem

It is an object of the present invention to provide a method of efficiently producing carbon fibers that can impart sufficient electrical or thermal conductivity to a material even by the addition of a small amount of the carbon fibers.

### Solution to Problem

The present inventors have diligently studied for achieving the object and, as a result, have accomplished the present invention encompassing the followings.

(1) A method of producing carbon fibers comprising:

supporting a catalytic element on a carrier composed of silica-titania particles to prepare a catalyst, and

bringing the catalyst into contact with a carbon element-containing material in a vapor phase.

(2) The method according to aspect (1), wherein the silica-titania particles have a core-shell structure.
(3) The method according to aspect (2), wherein the silica-titania particles comprise silica in the core and titania in the shell.
(4) The method according to aspect (2) or (3), wherein the silica-titania particles have a core/shell mass ratio of 90/10 to 99/1.
(5) The method according to any one of aspects (1) to (4), wherein the silica-titania particles have a silica/titania mass ratio of 90/10 to 99/1.
(6) The method according to any one of aspects (1) to (5), wherein the silica-titania particles have a 50% diameter in volume-based cumulative particle size distribution of 10 μm to 5000 μm.
(7) The method according to any one of aspects (1) to (6), wherein the silica-titania particles have a BET specific surface area of 50 m²/g to 500 m²/g.
(8) The method according to any one of aspects (1) to (7), wherein the silica-titania particles have a pore volume of 0.1 ml/g to 10 ml/g.
(9) The method according to any one of aspects (1) to (8), wherein the silica-titania particles have a pore volume of 0.6 ml/g to 1.5 ml/g and a specific surface area of 150 m²/g to 400 m²/g.
(10) The method according to any one of aspects (1) to (9), wherein the catalytic element comprises at least one selected from transition metal elements.
(11) The method according to any one of aspects (1) to (10), wherein the catalytic element comprises Fe element and/or Co element.
(12) The method according to aspect (11), wherein the catalytic element further comprises Mo element and/or V element.
(13) The method according to any one of aspects (1) to (10), wherein the catalytic element comprises Fe element, Co element and Mo element in which the amount of the Co element is 0 to 100 mol % relative to that of the Fe element and the amount of the Mo element is 1 to 20 mol % relative to that of the Fe element.
(14) The method according to any one of aspects (1) to (10), wherein the catalytic element comprises Co element, Fe element and Mo element in which the amount of the Fe element is 0 to 100 mol % relative to that of the Co element and the amount of the Mo element is 1 to 20 mol % relative to that of the Co element.
(15) The method according to any one of aspects (1) to (10), wherein the catalytic element comprises Fe element, Mo element and V element in which the amount of the Mo element is 1 to 10 mol % relative to that of the Fe element and the amount of the V element is 1 to 20 mol % relative to that of the Fe element.
(16) Carbon fibers comprising silica-titania particles and a transition metal element, in which the carbon fibers have a number-average fiber diameter of 5 to 100 nm and an aspect ratio of 5 to 1000.
(17) Carbon fibers comprising silica-titania particles and Fe element and/or Co element, in which the carbon fibers have a number-average fiber diameter of 5 to 100 nm and an aspect ratio of 5 to 1000.
(18) A carbon fiber bundle having a diameter of 1 μm or more and a length of 5 μm or more and formed by tangling the carbon fibers according to aspect (16) or (17).
(19) The carbon fiber bundle according to aspect (18), wherein the carbon fibers are tangled without being oriented to a specific direction.
(20) A carbon fiber mass composed of gathered carbon fiber bundles according to aspect (18) or (19).
(21) A paste or slurry comprising the carbon fibers according to aspect (16) or (17).
(22) A current collector comprising a layered product comprising an electrically conductive base material, and an electrically conductive layer comprising the carbon fibers according to aspect (16) or (17).
(23) An electrode comprising a layered product comprising an electrically conductive base material, and an electrode layer comprising the carbon fibers according to aspect (16) or (17) and an electrode active material.
(24) An electrode comprising a layered product comprising the current collector according to aspect (21), and an electrode layer comprising the carbon fibers according to aspect (16) or (17) and an electrode active material.
(25) An electrochemical device comprising the carbon fibers according to aspect (16) or (17).
(26) An electrically conductive material comprising the carbon fibers according to aspect (16) or (17).

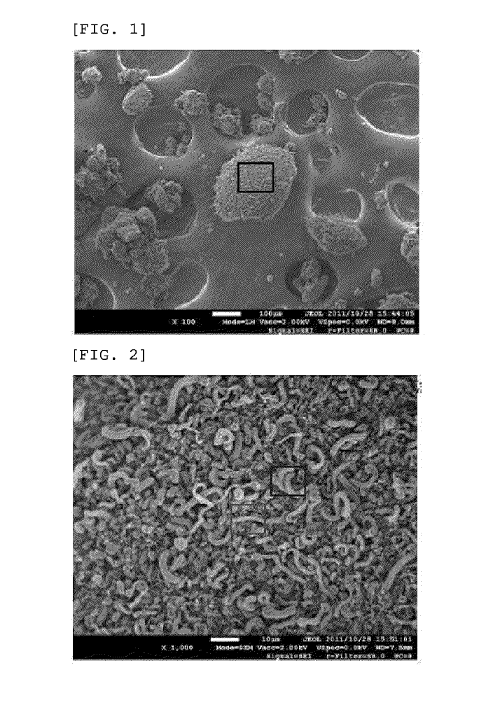

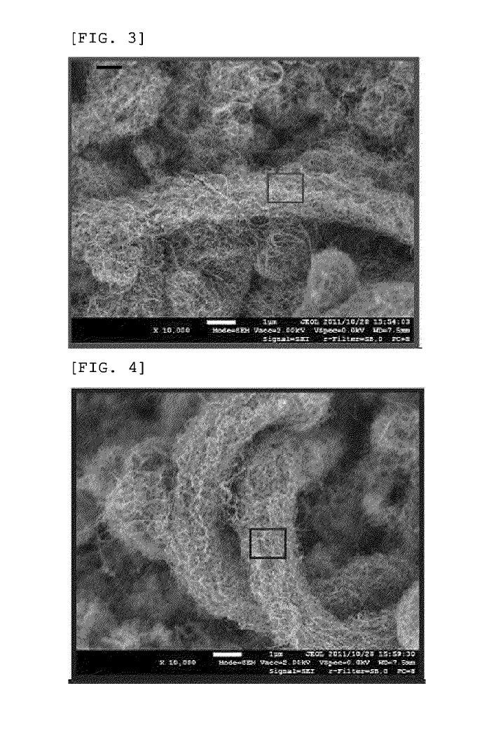

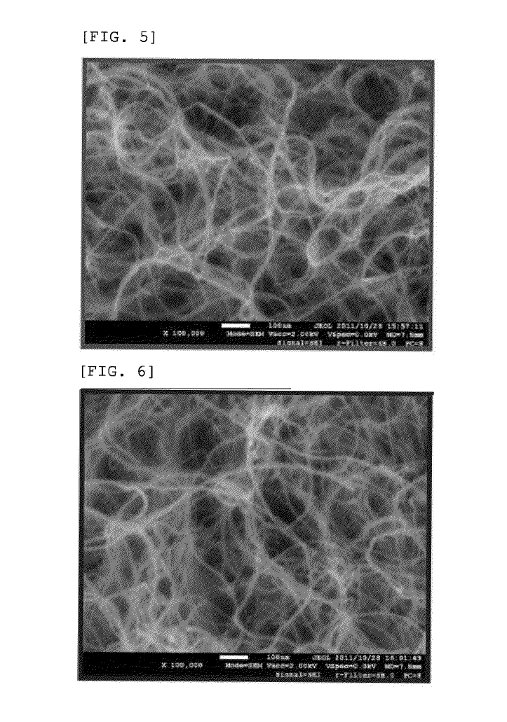

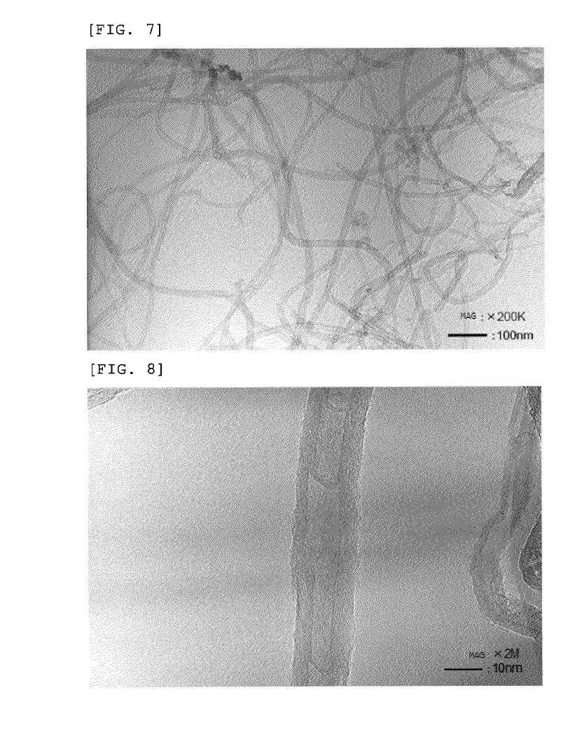

### BRIEF DESCRIPTION OF DRAWINGS

[FIG. 1] A scanning electron microscope photograph of carbon fiber masses prepared in Example 1.

[FIG. 2] A photograph of the portion enclosed by a rectangular frame of the carbon fiber mass indicated in FIG. 1.

[FIG. 3] A photograph of the portion enclosed by a rectangular frame (at the lower left) of the carbon fiber bundles indicated in FIG. 2.

[FIG. 4] A photograph of the portion enclosed by a rectangular frame (at the upper right) of the carbon fiber bundles indicated in FIG. 2.

[FIG. 5] A photograph of the portion enclosed by a rectangular frame of the carbon fibers indicated in FIG. 3.

[FIG. 6] A photograph of the portion enclosed by a rectangular frame of the carbon fibers indicated in FIG. 4.

[FIG. 7] A transmission electron microscope photograph of the carbon fibers prepared in Example 1.

[FIG. 8] A transmission electron microscope photograph of the carbon fibers prepared in Example 1.

### DESCRIPTION OF EMBODIMENTS

A method of producing carbon fibers according to a preferred embodiment of the present invention comprises supporting a catalytic element on a carrier composed of silica-titania particles to prepare a catalyst, and bringing the catalyst into contact with a carbon element-containing material in a vapor phase.

The carrier used in the present invention is composed of silica-titania particles. The silica-titania particles are particles comprising a complex of silica and titania.

The silica-titania particles preferably have a core-shell structure. The silica-titania particles having a core-shell structure have a core/shell mass ratio of preferably 80/20 to 99.5/0.5, more preferably 85/15 to 99/1, and most preferably 90/10 to 99/1.

The silica-titania particles having a core-shell structure preferably comprise silica in the core and titania in the shell.

The silica-titania particles have a silica/titania mass ratio of preferably 80/20 to 99.5/0.5, more preferably 85/15 to 99/1, and most preferably 90/10 to 99/1.

The silica-titania particles have a 50% diameter in volume-based cumulative particle size distribution of preferably 10 μm to 5 mm, more preferably 10 μm to 1 mm, more preferably 25 μm to 750 μm, and most preferably 50 μm to 500 μm. Herein, the 50% diameter is a value calculated from particle size distribution measured by a laser diffraction scattering method.

The silica-titania particles are preferably porous. The silica-titania particles have a pore volume of preferably 0.1 to 10 ml/g, more preferably 0.2 to 5 ml/g, and most preferably 0.6 to 1.5 ml/g.

The silica-titania particles have a BET specific surface area of preferably 50 to 500 m²/g, more preferably 150 to 450 m²/g, and most preferably 250 to 400 m²/g. The silica-titania particles specifically preferably are 0.6 to 1.5 ml/g in a pore volume and 150 to 400 m²/g in a BET specific surface area. Herein, the BET specific surface area is calculated by a BET method from the amount of nitrogen adsorption. When the BET specific surface area and/or the pore volume are within the above-mentioned ranges, the carbon fibers are highly efficiently formed, and the resulting carbon fibers have a high electrical or thermal conductivity-imparting effect.

The silica-titania particles are not limited by producing method thereof. The silica-titania particles can be prepared, for example, by immersion of titanyl sulfate in silica and then heat treatment at 400 to 600° C. under an oxidizing atmosphere; by hydrolysis of silicon with an alkoxide comprising titania and then heat treatment at 400 to 600° C. under an oxidizing atmosphere; or by coating through chemical vapor deposition using an alkoxide comprising silica or titania as a raw material and then heat treatment at 400 to 600° C. under an oxidizing atmosphere.

The catalytic element used in the present invention may be any element that enhances the growth of carbon fibers and preferably comprises at least one selected from the group consisting of transition metal elements in Groups 3 to 12 of the Periodic Table of Elements (IUPAC: 1990). In particular, the catalytic element comprises preferably at least one selected from the group consisting of transition metal elements in Groups 3, 5, 6, 8, 9 and 10, and more preferably at least one selected from Fe element, Ni element, Co element, Cr element, Mo element, W element, V element, Ti element, Ru element, Rh element, Pd element, Pt element, and rare-earth elements.

The catalytic element can be supported on the carrier in an elemental or compound form. Examples of catalytic element-containing compounds include inorganic salts such as nitrates, sulfates, carbonates or the like; organic salts such as acetates or the like; organic complexes such as acetylacetone complexes or the like; organic metal compounds; or the like. From the viewpoint of reactivity, nitrates and acetylacetone complexes are preferred.

The catalytic elements may be used alone or in a combination of two or more thereof. A combination of two or more of catalytic elements can control the reaction activity. Preferred examples of the combination of the catalytic elements include combinations comprising at least one element selected from Fe, Co and Ni, at least one element selected from Ti, V and Cr, and at least one element selected from Mo and W. In particular, catalytic element comprises preferably Fe element and/or Co element, and more preferably Fe element and/or Co element and Mo element and/or V element.

More specifically, the catalytic element preferably comprises Fe element, Co element and Mo element in which the amount of the Co element is 0 to 100 mol % relative to that of the Fe element and the amount of the Mo element is 1 to 20 mol % relative to that of the Fe element; Co element, Fe element and Mo element in which the amount of the Fe element is 0 to 100 mol % relative to that of the Co element and the amount of Mo element is 1 to 20 mol % relative to that of the Co element; or Fe element, Mo element and V element in which the amount of the Mo element is 1 to 10 mol % relative to that of the Fe element and the amount of V element is 1 to 20 mol % relative to that of the Fe element.

The catalyst used in the present invention may be prepared by any method. Examples of the method include a method of preparing a catalyst by impregnating a carrier with a solution comprising a catalytic element (impregnation method); and a method of preparing a catalyst by coprecipitating a solution comprising a catalytic element and a carrier constituent (coprecipitation method). Among these methods, preferred is the impregnation method.

In a more specific example of the impregnation method, a catalyst is prepared by dissolving or dispersing a catalytic element-containing material in a solvent, impregnating a granular carrier with the resulting solution or dispersion, and drying the impregnated product.

The solution comprising a catalytic element may be a liquid organic compound comprising a catalytic element or may be a solution or dispersion prepared by dissolving or dispersing a compound comprising a catalytic element in an organic solvent or water. The solution comprising a catalytic element may comprise a dispersant or surfactant for improving the dispersibility of the catalytic element in the solution. Preferred examples of the surfactant include cationic surfactants, anionic surfactants, and nonionic surfactants. The concentration of the catalytic element in the solution can be appropriately selected depending on the type of the solvent, the type of the catalytic element, and other factors. The amount of the solution comprising a catalytic element to be mixed with a carrier is preferably equivalent to the amount of liquid absorbed by the carrier to be used. The drying process after sufficient mixing of the solution comprising a catalytic element with the carrier is usually performed at 70 to 150° C. The drying may be vacuum drying. Furthermore, after drying, pulverization and classification are preferably performed to give appropriate sizes.

Subsequently, the resulting catalyst is brought into contact with a carbon element-containing material. The carbon element-containing material may be any material that can serve as a carbon element source. Examples of the carbon element-containing material include saturated aliphatic hydrocarbons such as methane, ethane, propane, butane, pentane, hexane, heptane, octane or the like; unsaturated aliphatic hydrocarbons such as butene, isobutene, butadiene, ethylene, propylene, acetylene or the like; alcohols such as methanol, ethanol, propanol, butanol or the like; aromatic hydrocarbons such as benzene, toluene, xylene, styrene, indene, naphthalene, anthracene, ethylbenzene, phenanthrene or the like; alicyclic hydrocarbons such as cyclopropane, cyclopentane, cyclohexane, cyclopentene, cyclohexene, cyclopentadiene, dicyclopentadiene, steroids or the like; hetero-atom-containing organic compounds such as methylthiol, methylethylsulfide, dimethylthioketone, phenylthiol, diphenylsulfide, pyridine, quinoline, benzothiophene, thiophene or the like; halogenated hydrocarbons such as chloroform, carbon tetrachloride, chloroethane, trichloroethylene or the like; other organic compounds such as cumene, formaldehyde, acetaldehyde, acetone or the like; carbon monoxide; carbon dioxide and so on. These materials can be used alone or in a combination of two or more thereof. In addition, for example, natural gases, gasoline, lamp oil, heavy oil, creosote oil, kerosene, turpentine oil, camphor oil, pine oil, gear oil, cylinder oil or the like can also be used as carbon element-containing materials. Among these materials, carbon monoxide, methane, ethane, propane, butane, ethylene, propylene, butadiene, methanol, ethanol, propanol, butanol, acetylene, benzene, toluene, xylene, and mixtures thereof are preferred, and ethylene, propylene, and ethanol are more preferred.

The method of synthesizing carbon fibers by bringing a catalyst into contact with a carbon element-containing material in a vapor phase can be performed in a similar manner to known vapor-phase growth. For example, the above-mentioned catalyst is set to a vertical or horizontal reactor heated at a predetermined temperature, and a carbon element-containing material is supplied with a carrier gas to the reactor to put the material into contact with the catalyst. The reactor may be a fixed-bed reactor in which a catalyst is placed in a boat (e.g., quartz boat) in the reactor or may be a fluidized-bed reactor in which a catalyst is allowed to flow with a carrier gas in the reactor. Since a catalyst may be in an oxidized state, the catalyst is preferably reduced by circulating a gas comprising a reducible gas before the supply of a carbon element-containing material. The temperature during the reduction is preferably 300 to 1000° C. and more preferably 500 to 700° C. The time for the reduction varies depending on the scale of the reactor and is preferably 10 minutes to 5 hours and more preferably 10 minutes to 60 minutes.

The carbon element-containing material is preferably supplied to the reaction field in a gaseous state. A carbon element-containing material that is a liquid or solid at room temperature is preferably vaporized by heating and is then supplied.

The carrier gas used for supplying the carbon element-containing material is preferably a reducible gas such as hydrogen gas or the like. The amount of the carrier gas can be appropriately selected depending on the type of the reactor and is preferably 0.1 to 70 parts by mole relative to 1 part by mole of the carbon element-containing material. In addition to the reducible gas, an inert gas, such as nitrogen gas, helium gas, argon gas, krypton gas or the like, may be simultaneously used. Furthermore, the composition ratio of the gas may be varied during the progress of the reaction. The concentration of the reducible gas is preferably 1% by volume or more, more preferably 30% by volume or more, and most preferably 85% by volume or more relative to the total volume of the carrier gas.

The amount of the carbon element-containing material to be supplied varies depending on the catalyst, the carbon element-containing material and the type of the reactor to be used or the reaction conditions and therefore cannot be unambiguously determined, but the value of (the flow rate of gaseous carbon element-containing material)/[(the flow rate of carrier gas)+(the flow rate of gaseous carbon element-containing material)] is preferably 10 to 90% by volume and more preferably 30 to 70% by volume. In the case of using ethylene as a carbon element-containing material, the value is preferably 30 to 90% by volume.

The temperature of the contact region of the catalyst and the carbon element-containing material is preferably 400 to 1100° C., more preferably 500 to 1000° C., even more preferably 530 to 850° C., and most preferably 550 to 800° C. A too low temperature and also a too high temperature may significantly reduce the yield of carbon fibers. In addition, a high temperature that causes side reaction is apt to cause adhesion of a large amount of non-conductive material to the surfaces of carbon fibers.

The carbon fibers formed by contact between a catalyst and a carbon element-containing material are optionally subjected to treatments such as pulverization, air oxidation, acid treatment, heat treatment or the like.

Carbon fibers according to a preferred embodiment of the present invention are produced by the method described above and thereby comprise silica-titania particles and a transition metal element, preferably Fe element and/or Co element. The carbon fibers according to a preferred embodiment of the present invention have a number-average fiber diameter of preferably 5 to 100 nm, more preferably 5 to 30 nm and an aspect ratio (fiber length/fiber diameter) of 5 to 1000. In the carbon fibers according to a preferred embodiment of the present invention, 90% or more of the fibers have a diameter within a range of 5 to 30 nm in the number-based fiber diameter distribution. The average fiber diameter and the average fiber length are each determined as a number average value by measuring diameters and lengths of 100 or more fibers in about 10 visual fields photographed with a transmission electron microscope at a magnification of about ×200,000. Preferred carbon fibers have a specific surface area of preferably 20 to 400 m²/g, more preferably 150 to 250 m²/g, and most preferably 150 to 230 m²/g. The specific surface area is determined by a BET method from the amount of nitrogen adsorption.

The carbon fibers according to the present invention preferably have a tube shape having a hollow at the center (see FIG. 7). The hollow may be continuous or discontinuous in the fiber longitudinal direction. The ratio (d₀/d) of the hollow diameter d₀ to the fiber diameter d is not particularly limited and is usually 0.1 to 0.8.

In the carbon fibers according to a preferred embodiment of the present invention, d₀₀₂ is preferably 0.335 to 0.345 nm and more preferably 0.338 to 0.342 nm. d₀₀₂ is calculated from a diffraction spectrum measured by powder X-ray diffractometry (Gakushin-method).

In a preferred embodiment according to the present invention, the carbon fibers are preferably tangled to form carbon fiber bundles (see FIG. 2, 3 or 4). The carbon fiber bundles preferably have a diameter of 1 μm or more, more preferably 1.5 to 8 μm and a length of 5 μm or more, more preferably 10 to 30 μm. The diameter and the length of a carbon fiber bundle are measured from an electron microscope photograph.

In the carbon fiber bundle, the carbon fibers are preferably tangled without being oriented to a specific direction (see FIG. 5 or 6). Herein, orientation of carbon fibers can be judged by drawing two parallel lines with a distance of about 100 nm on an electron microscope photograph, measuring intersection angles (directions of fibers) between the lines and the axes of carbon fibers, and determining the frequency distribution of the angles. For example, in the case shown in FIG. 5, about 20% of the fibers have an intersection angle of 0 to 30°, about 20% of the fibers have an intersection angle of 30 to 60°, about 20% of fibers have an intersection angle of 60 to 90°, about 20% of the fibers have an intersection angle of 90 to 120°, about 14% of the fibers have an intersection angle of 120 to 150°, and about 8% of the fibers have an intersection angle of 150 to 180°. In the case shown in FIG. 6, about 0% of the fibers have an intersection angle of 0 to 30°, about 34% of the fibers have an intersection of 30 to 60°, about 27% of the fibers have an intersection angle of 60 to 90°, about 14% of the fibers have an intersection angle of 90 to 120°, about 20% of the fibers have an intersection angle of 120 to 150°, and about 8% of the fibers have an intersection angle of 150 to 180°. The directions of the fibers are random in both cases, and no orientation to a specific direction was observed.

In a preferred embodiment according to the present invention, the carbon fiber bundles are preferably gathered to form carbon fiber masses (see FIG. 1 or 2).

The carbon fiber masses according to a preferred embodiment of the present invention have a volume resistivity (consolidation specific resistance) of preferably 0.04Ω·cm or less, more preferably 0.03Ω·cm or less, at a density of 0.8 g/cm³. The carbon fiber masses according to a preferred embodiment of the present invention have a bulk density of preferably 0.01 to 0.2 g/cm³ and more preferably 0.02 to 0.15 g/cm³.

The carbon fibers, carbon fiber bundles, and carbon fiber masses according to the present invention have excellent permeability or dispersibility in a matrix such as a resin, a liquid or the like. Therefore, a composite material having high electrical or thermal conductivity can be obtained by adding the carbon fibers to a matrix. The composite material has excellent antistatic properties. In order to obtain sufficient electrical or thermal conductivity, the amount of the carbon fibers to be added to a matrix is preferably 0.5 to 10% by mass and more preferably 0.5 to 5% by mass.

Examples of the resin to which the carbon fibers according to the present invention are added include thermoplastic resins, thermosetting resins, and photocurable resins. The thermoplastic resin may comprise a thermoplastic elastomer or a rubber constituent for improving the shock resistance.

Usable examples of the thermosetting resin include polyamides, polyethers, polyimides, polysulfones, epoxy resins, unsaturated polyester resins, phenol resins or the like. Usable examples of the photocurable resin include radica-curable resins (acrylic monomers, acrylic oligomers such as polyester acrylate, urethane acrylate, and epoxy acrylate, unsaturated polyesters, and enethiol polymers), cation-curable resins (epoxy resins, oxetane resins, and vinyl ether resins) or the like. Usable examples of the thermoplastic resin include nylon resins, polyethylene resins, polyamide resins, polyester resins, polycarbonate resins, polyarylate resins, cyclopolyolefin resins or the like.

A resin material comprising the carbon fibers according to the present invention can further comprise various resin additives within ranges that do not impair the properties and functions of the resin. Examples of the resin additives include coloring agents, plasticizers, lubricants, heat stabilizers, light stabilizers, UV absorbers, fillers, foaming agents, flame retardants, corrosion inhibitors, antioxidants or the like. These resin additives are preferably added in the final step of preparing the resin material.

The resin composite material comprising the carbon fibers according to the present invention can be suitably used as a molding material for products required to have electrical conductivity and antistatic properties as well as shock resistance, such as OA equipment, electronic equipment, electrically conductive packaging parts, electrically conductive sliding members, electrically and thermally conductive members, antistatic packaging parts, and automobile parts to which electrostatic coating is applied. Examples of the molding material include a current collector composed of a layered product comprising an electrically conductive layer comprising the carbon fibers according to the present invention, an electrode composed of a layered product comprising an electrode layer comprising the carbon fibers according to the present invention, an electrode composed of a layered product comprising the current collector and an electrode layer comprising the carbon fibers according to the present invention, an electrochemical device comprising the carbon fibers according to the present invention, and an electrically conductive material comprising the carbon fibers according to the present invention.

These products can be produced by a known resin molding method. Examples of the molding method include injection molding, hollow molding, extrusion molding, sheet molding, heat molding, rotational molding, lamination molding, and transfer molding.

Preferred examples of liquid dispersions of the carbon fibers according to the present invention include thermally conductive fluids wherein the carbon fibers are dispersed in liquid such as water, alcohol, or ethylene glycol; liquid dispersions for forming electrically conductive or antistatic paints or coatings dispersing the carbon fibers together with paints and binder resins therein.

In addition, the carbon fibers according to the present invention have a high electrical conductivity-imparting effect and therefore can be suitably used in electrochemical devices such as batteries and capacitors.

Application of carbon fibers to the electrode for an electrochemical device is described in, for example, JP 2005-63955 A. Specifically, a method involving preparing a slurry or paste comprising the carbon fibers according to the present invention and laminating the slurry or paste onto an electrically conductive base material can produce a current collector composed of a layered product including an electrically conductive base material and an electrically conductive layer, an electrode composed of a layered product including an electrically conductive base material and an electrode layer, or an electrode composed of a layered product including a current collector (a layered product composed of an electrically conductive base material and an electrically conductive layer) and an electrode layer.

The slurry or paste according to the present invention may comprise a material for constituting the electrically conductive layer or electrode layer, in addition to the carbon fibers.

The electrically conductive layer usually comprises a binder material. The electrode layer optionally comprises a conductive assistant such as carbon black or the like. The slurry or paste may comprise a thickener for controlling the viscosity, for example, a polymer such as carboxymethyl cellulose or its salt (e.g., sodium carboxymethyl cellulose) or polyethylene glycol. The electrode layer usually comprises a known electrode active material that can be added to an electrically conductive layer, in addition to the above-mentioned materials.

Examples of the binder material for the electrode layer include fluorine-containing polymers such as polyvinylidene fluoride, polytetrafluoroethylene or the like; and rubber polymers such as styrene butadiene rubber (SBR) or the like. Examples of the binder material for the electrically conductive layer include the fluorine-containing polymers and the rubber polymers mentioned above and also polysaccharides and crosslinked products of polysaccharides. The solvent may be any known solvent that is suitable for each binder. For example, toluene, N-methylpyrrolidone, or acetone can be used for fluorine-containing polymers; and water can be used for SBR.

The preparing method of slurry or paste is not limited. For example, a slurry or paste for electrode layer can be prepared by mixing an electrode active material, carbon fibers and a binder material all at once; by mixing an electrode active material and carbon fibers and then mixing the mixture with a binder material; by mixing an electrode active material and a binder and then mixing the mixture with carbon fibers; or by mixing carbon fibers and a binder material and then mixing the mixture with an electrode active material. In the mixing, both dry blending without using a solvent and wet blending using a solvent can be employed. For example, an electrode active material, carbon fibers, or a mixture thereof is mixed with a binder material by dry blending, and a solvent is then added thereto, followed by kneading of the mixture. Alternatively, a binder material is diluted with a solvent, and an electrode active material, carbon fibers, or a mixture thereof is added thereto, followed by kneading of the mixture. The carbon fibers according to the present invention have excellent dispersibility in an organic solvent. Therefore, an electrically conductive layer or an electrode layer can comprise the carbon fibers in a high dispersion state.

Examples of the electrically conductive base material used in the electrode or current collector include metal base materials such as copper, aluminum, stainless steel, nickel, and alloys thereof and carbon base materials such as carbon sheets.

There is no limitation for the method of laminating the electrically conductive layer or electrode layer onto the electrically conductive base material. For example, a method described in JP 2007-226969 A or WO 07/043,515 A can be employed. Specifically, a method involving applying a slurry or paste to an electrically conductive base material or a current collector by a known coating method such as doctor blading or bar coating, drying the solvent, drying the coated film and then pressing the layered product can be employed.

The carbon fibers according to the present invention have a high absorbed liquid holding capacity, as well as excellent dispersibility in an electrically conductive layer or electrode layer, and therefore can enhance cycle characteristics and other characteristics. Furthermore, the use of the carbon fibers according to the present invention can significantly decrease the resistance value of the electrode, resulting in a decrease in internal resistance of a battery or capacitor to enhance the high rate performance.

### EXAMPLES

The present invention will now be more specifically described by examples of the invention. It should be noted that these examples are provided for illustrative purposes and the present invention is not limited to these examples.

Physical properties and other properties were measured by the following methods.

### (Bulk Density)

One grams of carbon fibers were put in a measuring cylinder, and the measuring cylinder was shaken for 1 minute on a shaker (Touch Mixer MT-31, manufactured by Yamato Scientific Co., Ltd.). Subsequently, the volume of the carbon fibers was measured to calculate the bulk density.

### (Consolidation Specific Resistance)

Carbon fiber masses (0.2 g) were precisely weighed, and volume resistivity at each density was measured with a powder resistance measurement system (MCP-PD51, manufactured by Mitsubishi Chemical Analytech Co., Ltd.).

### (Increase in Mass)

The increase in mass was represented by a ratio of the mass of the resulting carbon fibers to the mass of the used catalyst (mass of carbon fibers/mass of catalyst).

### Example 1

One part by mass of silica-titania particles [1] (ST205, manufactured by Fuji Silysia Chemical Ltd., BET specific surface area: 257 m²/g, nominal particle diameter: 75 to 150 μm, pore volume: 1.14 ml/g, titania/silica mass ratio: 7/93, titania crystal structure: anatase type, silica core-titania shell structure) as a carrier were mixed with an aqueous solution of iron nitrate nonahydrate, cobalt nitrate hexahydrate, and hexaammonium heptamolybdate. The mixture was then dried at 110° C. for 16 hours with a hot air dryer to obtain catalyst A1 comprising the carrier supporting catalytic elements composed of 20 parts by mass of Fe element relative to 80 parts by mass of the carrier, 100 mol % of Co element relative to the amount of the Fe element, and 10 mol % of Mo element relative to the amount of the Fe element.

Catalyst A1 was weighed and was placed on a quartz boat. The quartz boat was put in a quartz tube reactor, and the tube reactor was sealed. The inside of the tube reactor was replaced with a nitrogen gas, and the reactor was heated from room temperature to 690° C. over 60 minutes under nitrogen gas flow and was maintained at 690° C. for 30 minutes under nitrogen gas flow.

Subsequently, a gas mixture of a hydrogen gas (250 parts by volume) and an ethylene gas (250 parts by volume), instead of the nitrogen gas, was allowed to flow in the reactor with maintaining the temperature at 690° C. for 60 minutes for vapor phase growth. The gas mixture was changed to a nitrogen gas to replace the inside of the reactor with a nitrogen gas. The reactor was cooled to room temperature, and the quartz boat was taken out from the reactor. As a result, carbon fibers that grew using the catalyst as a nucleus were obtained.

The increase in mass (mass of carbon fibers collected after the reaction/mass of the catalyst) was 61.6. FIGS. 1 to 6 show scanning electron microscope photographs of the resulting carbon fibers, and FIGS. 7 and 8 show transmission electron microscope photographs. The carbon fibers had an average fiber diameter (diameter) of 13.2 nm, wherein 90% or more fibers were in a range of 5 to 30 nm in the fiber diameter distribution (in number basis), and had an average fiber length of 6 μm and an aspect ratio of 450. The carbon fibers were tangled without being oriented to a specific direction to form carbon fiber bundles. The carbon fiber bundles further aggregated to form carbon fiber masses. The carbon fiber masses had a BET specific surface area of 167 m²/g, a consolidation specific resistance of 0.018Ω·cm, and a bulk density of 0.111 g/cm³. Table 1 shows the properties of the carbon fibers.

### Example 2

Catalyst A2 and carbon fibers were prepared by the same means as in Example 1 except that the catalytic element was composed of 20 parts by mass of Fe element relative to 80 parts by mass of the carrier, 0 mol % of Co element relative to the amount of the Fe element, and 10 mol % of Mo element relative to the amount of the Fe element. The properties of the carbon fibers are shown in Table 1.

### Example 3

Catalyst A3 and carbon fibers were prepared by the same means as in Example 1 except that the catalytic element was composed of 10 parts by mass of Fe element relative to 90 parts by mass of the carrier, 100 mol % of Co element relative to the amount of the Fe element, and 10 mol % of Mo element relative to the amount of the Fe element. The properties of the carbon fibers are shown in Table 1.

### Example 4

Catalyst A4 and carbon fibers were prepared by the same means as in Example 1 except that the catalytic element was composed of 20 parts by mass of Fe element relative to 80 parts by mass of the carrier, 3 mol % of Mo element relative to the amount of the Fe element, and 20 mol % of V element relative to the amount of the Fe element and that the reaction temperature was changed to 640° C. The properties of the carbon fibers are shown in Table 1. As the raw material of the V element, ammonium metavanadate was used.

### Example 5

Catalyst A5 and carbon fibers were prepared by the same means as in Example 1 except that silica-titania particles [2] (silica-titania powder Jupiter S F4S05, manufactured by Showa Titanium Co., Ltd., BET specific surface area: 47 m²/g, nominal particle diameter: 0.03 μm, titania/silica mass ratio: 95/5, titania crystal structure: anatase type, titania core-silica shell structure) were used instead of silica-titania particles [1]. The properties of the carbon fibers are shown in Table 1.

### Example 6

Catalyst A6 and carbon fibers were prepared by the same means as in Example 1 except that the catalytic element was composed of 20 parts by mass of Co element relative to 80 parts by mass of the carrier, 20 mol % of Fe element relative to the amount of the Co element, and 10 mol % of Mo element relative to the amount of the Co element. The properties of the carbon fibers are shown in Table 1.

### Example 7

Catalyst A7 and carbon fibers were prepared by the same means as in Example 1 except that the catalytic element was composed of 20 parts by mass of Co element relative to 80 parts by mass of the carrier, 50 mol % of Fe element relative to the amount of the Co element, and 10 mol % of Mo element relative to the amount of the Co element. The properties of the carbon fibers are shown in Table 1.

### Comparative Example 1

A catalyst and carbon fibers were prepared by the same means as in Example 1 except that γ-alumina particles (manufactured by Strem Chemicals Inc., BET specific surface area: 130 m²/g, 50% diameter: 10 μm) were used instead of silica-titania particles [1]. The properties of the carbon fibers are shown in Table 1.

### Comparative Example 2

A catalyst and carbon fibers were prepared by the same means as in Example 1 except that silica gel (CARiACT Q-15, manufactured by Fuji Silysia Chemical Ltd., BET specific surface area: 191 m²/g, nominal particle diameter: 1700 to 4000 μm, pore volume: 0.99 ml/g) was used instead of silica-titania particles [1]. The properties of the carbon fibers are shown in Table 1.

### [Table 1]

TABLE 1

| | | | | Specific | | Consolidation |
|---|---|---|---|---|---|---|
| | Supported catalyst | | | surface | Bulk | specific |
| | | catalytic | Increase | area | density | resistance |
| | carreer | metal | in mass | [m²/g] | [g/cm³] | [Ωcm] |
| Ex. 1 | Silica-titania | 20Fe100Co10Mo | 61.6 | 167 | 0.111 | 0.018 |
| | particles[1] | | | | | |
| Ex. 2 | Silica-titania | 20Fe10Mo | 19.3 | — | — | — |
| | particles[1] | | | | | |
| Ex. 3 | Silica-titania | 10Fe100Co10Mo | 27.0 | 177 | 0.091 | 0.021 |
| | particles[1] | | | | | |
| Ex. 4 | Silica-titania | 20Fe3Mo20V | 20.9 | — | — | — |
| | particles[1] | | | | | |
| Ex. 5 | Silica-titania | 20Fe100Co10Mo | 37.6 | 113 | 0.154 | 0.032 |
| | particles[2] | | | | | |
| Ex. 6 | Silica-titania | 20Co20Fe10Mo | 45.7 | 216 | — | 0.018 |
| | particles[1] | | | | | |
| Ex. 7 | Silica-titania | 20Co50Fe10Mo | 58.0 | 179 | — | 0.017 |
| | particles[1] | | | | | |
| Comp. | γ-alumina | 20Fe100Co10Mo | 6.0 | — | — | — |
| Ex. 1 | particles | | | | | |
| Comp. | Silica gel | 20Fe100Co10Mo | 1.9 | — | — | — |
| Ex. 2 | | | | | | |

### Example 8

The carbon fibers prepared in Example 1 were crushed at a crushing pressure of 0.5 MPa with a counter jet mill (100AFG/50ATP, manufactured by Hosokawa Alpine AG). The crushed carbon fibers had a specific surface area of 170 m²/g, a bulk density of 0.040 g/cm³, and a consolidation specific resistance of 0.020Ω·cm. In the carbon fibers, the ratio (d₀/d) of the hollow diameter do to the fiber diameter d was 0.5, and the d₀₀₂ was 0.340 nm.

### (Production of Battery Cathode)

A powder mixture was prepared by putting 90 parts by mass of a cathode active material (LFP-NCO: LiFePO₄ manufactured by Aleees, average particle diameter: 2 μm), 2 parts by mass of the crushed carbon fibers, and parts by mass of acetylene black (Denka Black, manufactured by Denki Kagaku Kogyo Kabushiki Kaisha) in a dry mixer (Nobilta, manufactured by Hosokawa Micron Ltd., peripheral velocity: 30 to 50 m/s, effective volume: 500 ml) and dry-mixing the mixture for 12 minutes by setting the peripheral velocity of the mixing blade to 40 m/s. Subsequently, the powder mixture was transferred to a slurry kneader (TK-Hivis Mix f-Model 03, manufactured by Primix Corporation), and a vinylidene fluoride resin binder (KF-Polymer L#1320: a solution of vinylidene fluoride resin (PVDF) in N-methyl-2-pyrrolidone, manufactured by Kureha Corporation) in an amount of 5 parts by mass as the amount of PVDF was added to the kneaded mixture, followed by kneading. The kneading was further continued while adding N-methyl-2-pyrrolidone (manufactured by Showa Denko K.K.) into the mixture to give a slurry having a viscosity suitable for application. The resulting slurry was applied onto aluminum foil with an automatic coater and a doctor blade, followed by drying on a hot plate (80° C.) for 30 minutes and then with a vacuum dryer (120° C.) for 1 hour. Subsequently, the resulting sheet was punched into a predetermined size and was pressed with a press molding machine at a pressure of 5 MPa. The pressed sheet was dried with a vacuum dryer (120° C.) for 12 hours to give a cathode having an electrode density of 1.89 g/cm³.

### (Preparation of Electrolytic Solution)

An electrolytic solution was prepared by dissolving LiPF₆ as an electrolyte in a solvent mixture of 2 parts by mass of ethylene carbonate (EC) and 3 parts by mass of ethylmethyl carbonate (EMC) at a concentration of 1.0 mol/L.

### (Production of Li-Ion Battery Test Cell)

The following procedure was conducted in a dry argon atmosphere at a dew point of −80° C. or less.

Four sheets of a polypropylene microporous film (25 μm, Celgard 2400, manufactured by Celgard, LLC) were prepared as separator sheets. A layered product was prepared by stacking a first separator sheet, a reference electrode (lithium metal foil), a second separator sheet, the cathode produced above, a third separator sheet, a counter electrode (lithium metal foil), and a fourth separator sheet in this order. The layered product was wrapped with aluminum laminate, and three sides were heat-sealed. The electrolytic solution was poured into the laminate pack, and the laminate pack was heat-sealed in vacuo to give a test cell.

### (Large-Current Load Test)

Constant current charge at a current of 0.2 C from a rest potential to 4.2 V, then constant voltage charge at 2 mV was performed, and the charge was stopped at the time when the current value decreased to 12 μA. Subsequently, constant current discharge was conducted at a current value corresponding to 0.2 C or 2.0 C until a cut-off voltage of 2.5 V.

The ratio of the capacity in the discharge at a current value corresponding to 2.0 C to the capacity in the discharge at a current value corresponding to 0.2 C was calculated as a capacity ratio (high-rate discharge capacity retention).

### Comparative Example 3

A cathode having an electrode density of 1.86 g/cm³ was prepared by the same means as in Example 8 except that the amount of carbon fibers was 0 part by mass and the amount of acetylene black was 5 parts by mass. The same test as in Example 8 was performed, and the results are shown in Table 2.

TABLE 2

| | | | Ex. 8 | Comp. Ex. 3 |
|---|---|---|---|---|
| Cathode active | LFP-NCO | parts by mass | 90 | 90 |
| material | | | | |
| Carbon-based | Carbon fibers | parts by mass | 2 | 0 |
| conductive | Acetylene black | parts by mass | 3 | 5 |
| assistant | | | | |
| Binder | PVDF | parts by mass | 5 | 5 |
| Battery | Discharge | 0.2 C | 150 | 138 |
| properties | capacity(mAh) | 2 C | 125 | 83 |
| | Capacity ratio | — | 83% | 60% |
| | (2 C/0.2 C) | | | |

The results above demonstrate that carbon fibers, carbon fiber bundles, or carbon fiber masses having a large specific surface area and a low consolidation specific resistance can be efficiently produced by bringing a catalyst comprising a carrier composed of silica-titania particles into contact with a carbon element-containing material in a vapor phase according to the present invention and also demonstrate that a lithium ion battery comprising carbon fibers prepared by the method of the present invention has an enhanced high-rate discharge capacity retention.

1. A method of producing carbon fibers comprising:
supporting a catalytic element on a carrier composed of silica-titania particles to prepare a catalyst, and
bringing the catalyst into contact with a carbon element-containing material in a vapor phase.

2. The method according to claim 1, wherein the silica-titania particles have a core-shell structure.

3. The method according to claim 2, wherein the silica-titania particles comprise silica in the core and titania in the shell.

4. The method according to claim 2, wherein the silica-titania particles have a core/shell mass ratio of 90/10 to 99/1.

5. The method according to claim 3, wherein the silica-titania particles have a silica/titania mass ratio of 90/10 to 99/1.

6. Carbon fibers comprising silica-titania particles and a transition metal element, in which the carbon fibers have a number-average fiber diameter of 5 to 100 nm and an aspect ratio of 5 to 1000.

7. A carbon fiber bundle having a diameter of 1 μm or more and a length of 5 μm or more, and formed by tangling the carbon fibers according to claim 6.

8. The carbon fiber bundle according to claim 7, wherein the carbon fibers are tangled without being oriented to a specific direction.

9. A carbon fiber mass composed of gathered carbon fiber bundles according to claim 7.

10. A paste or slurry comprising the carbon fibers according to claim 6.

11. An electrochemical device comprising carbon fibers according to claim 6.

12. An electrically conductive material comprising carbon fibers according to claim 6.

13. The method according to claim 1, wherein the silica-titania particles have a core/shell mass ratio of 90/10 to 99/1.

14. A carbon fiber mass composed of gathered carbon fiber bundles according to claim 8.
